(19) United States
(12) Patent Application Publication
(10) Pub. No.: US 2018/0344000 A1
(43) Pub. Date: Dec. 6, 2018

(54) PEDICURE SYSTEM HAVING PEDICURE STATION AND COVER CONFIGURED TO FUNCTION AS A BATH

(71) Applicant: Lisa Humphrey, Des Moines, IA (US)

(72) Inventor: Lisa Humphrey, Des Moines, IA (US)

(21) Appl. No.: 15/995,307

(22) Filed: Jun. 1, 2018

Related U.S. Application Data
(60) Provisional application No. 62/514,124, filed on Jun. 2, 2017.

(51) Int. Cl. A45D 29/20; A61H 35/00; A45D 29/22

(52) U.S. Cl. CPC A45D 29/20; A45D 2200/25; A45D 29/22; A61H 35/006

(57) ABSTRACT

Disclosed is a pedicure system comprising a cover and a pedicure station, wherein the cover is removably connected to the pedicure system and is further configured to receive a human foot and function as a bath and the pedicure station includes a plurality of storage compartments.

### CROSS REFERENCE TO RELATED APPLICATIONS

This application claims priority under 35 U.S.C. § 119(e) to U.S. Provisional Application entitled, “PEDICURE SYSTEM HAVING PEDICURE STATION AND COVER CONFIGURED TO FUNCTION AS A BATH,” Ser. No. 62/514,124, filed on Jun. 2, 2017. The entire contents of this patent application is hereby expressly incorporated herein by reference, including, without limitation, the specification, claims, and abstract, as well as any figures, tables, or drawings thereof.

### TECHNICAL FIELD

The disclosure relates to a cosmetology apparatus, and particularly to a pedicure system with a pedicure station having multiple compartments and a cover configured to function as a foot bath for either personal or commercial use.

### BACKGROUND

Pedicure stations and foot baths are common in the art, however, there is a need for an apparatus which is both portable and provides for multiple functions, such as a pedicure station and foot bath while being configured to efficiently store equipment and products necessary to provide a pedicure at the convenience of the user in any location.

### SUMMARY

In general, the disclosure relates to a cosmetology apparatus, and particularly to a pedicure system with a pedicure station having multiple compartments and a cover configured to function as a foot bath for either personal or commercial use.

In an aspect of the disclosure, a pedicure system comprising: a pedicure station configured to receive a human foot; and a plurality of storage units, wherein the storage units are drawers and are contained with the pedicure station. In a further aspect of the disclosure, the pedicure system further comprises a cover removably connected to the pedicure system and further configured to receive a human foot and function as a bath. In some aspects of the disclosure, the cover further comprises a non-slip base and a handle and may further comprise abrasive material affixed to the inside of the cover. In a still further aspect of the disclosure, the pedicure station further comprises pop-up toe separators. In a still further aspect of the disclosure, the pedicure station further comprises raised toe separators. In an additional aspect of the disclosure, the pedicure station further comprises an adjustable footrest. In an additional aspect of the disclosure, the pedicure station further comprises at least one heel rest. In an additional aspect of the disclosure, the pedicure station further comprises gel foot pads.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

FIG. 1A is a perspective view of a pedicure system in accordance with example embodiments. FIG. 1B is another perspective view of a pedicure system in accordance with example embodiments.

FIG. 2 is a top view of the cover.

FIG. 3 is a top view of the pedicure station.

FIG. 4A is a perspective view of the pedicure station of FIG. 3.

FIG. 4B is an alternative top view of the pedicure station of FIG. 3.

FIG. 4C is a side view of the pedicure station of FIG. 3.

FIG. 5A is a top view of an alternative embodiment of the pedicure station.

FIG. 5B is a side view of the alternative embodiment of the pedicure station of FIG. 5A.

FIG. 6 is a side view of the alternative embodiment of the pedicure station of FIG. 5A.

FIG. 7 is an exploded view of the pedicure system of FIG. 1B.

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and presented for exemplary illustration of the disclosure.

### DETAILED DESCRIPTION

Example embodiments will now be described more fully with reference to the accompanying drawings. Example embodiments are not intended to limit the disclosure since the disclosure may be embodied in different forms. Rather, example embodiments are provided so that this disclosure will be thorough and complete, and will fully convey the scope of the disclosure to those skilled in the art. In the drawings, the sizes of components may be exaggerated for clarity.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Example embodiments relate to pedicure systems.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form, unless otherwise indicated.

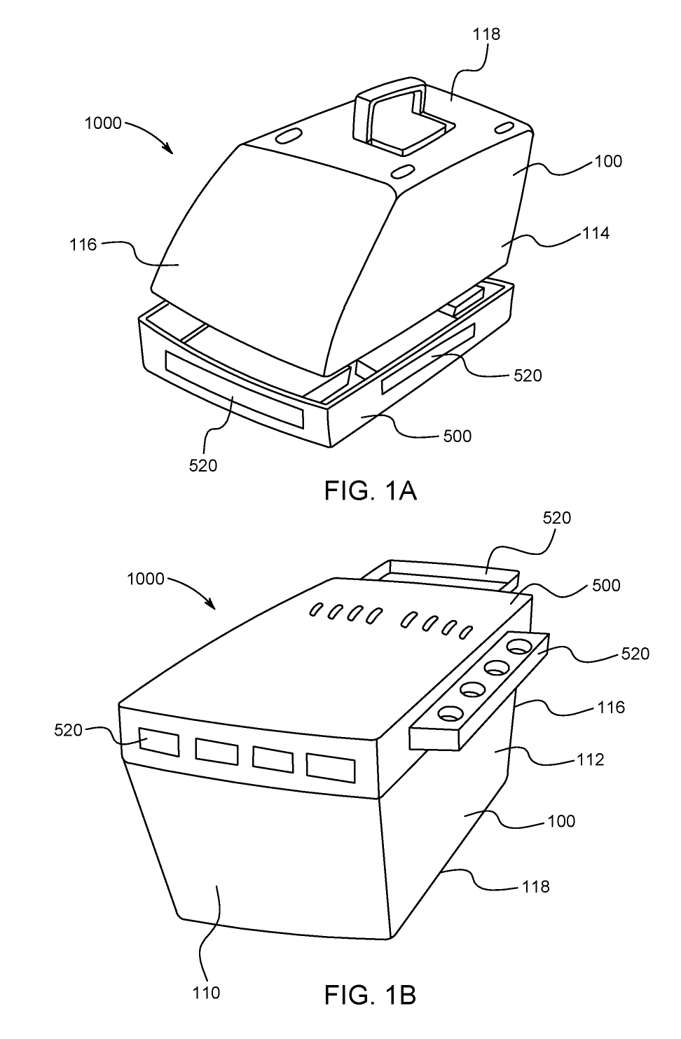

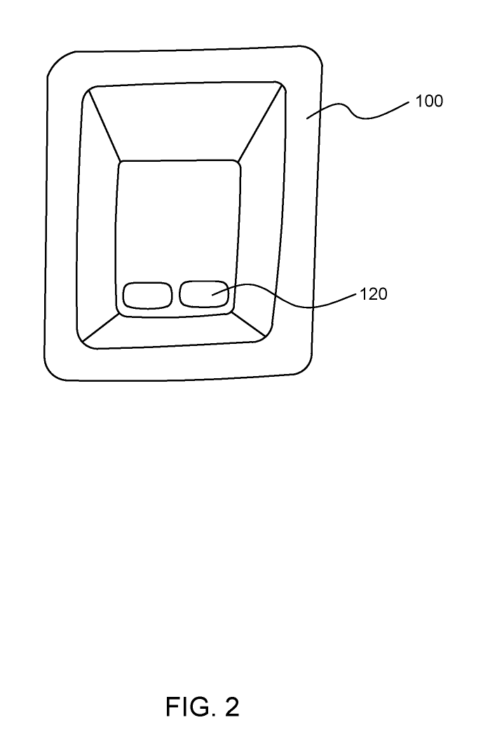

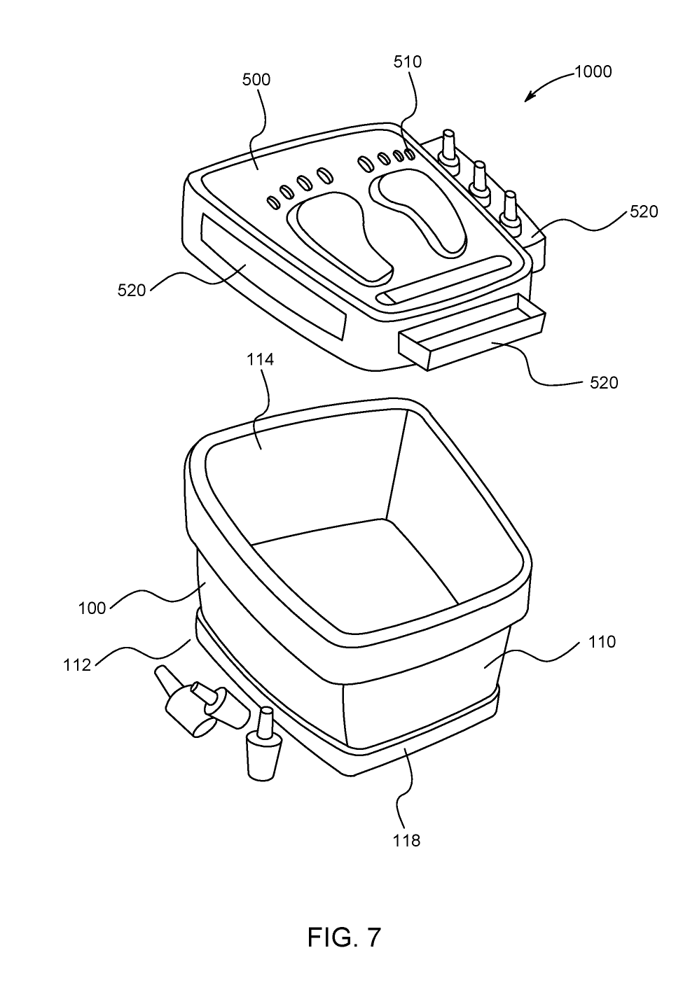

FIGS. 1A-1B illustrate a pedicure system 1000 in accordance with an example of the disclosure. As shown in FIGS. 1A-1B, the pedicure system 1000 includes a cover 100 and a pedicure station 500. The cover 100 may resemble an open box having a front wall 110, a first side wall 112, a second side wall 114, a back wall 116, and a top 118. The cover 100 may be configured to function as a foot bath and may be removably connected to the pedicure station 500. For example, the cover 100 may be flipped upside down to receive and hold water enabling it to function as a bath for the human foot. In other words, the cover 100 may be configured to hold water and accommodate a human foot. For example, the cover 100 may have a length of about fourteen inches, a width of about ten inches, and a depth of about seven inches. In an alternative embodiment, as shown in FIGS. 1B and 7, the cover 100 may be flipped upside down to receive the pedicure station 500, so that the pedicure station rests in the opening of the cover 500, and allows for additional height when utilizing the pedicure system 1000. Furthermore, the cover 100 may include non-slip pads on the top 118 so that when the cover 100 is flipped over, the non-slip pads of the top 118 contact the ground. For example, the cover 100 may have rubber strips mounted on the top surface of the top 118 to prevent the cover 100 from sliding on a floor when the cover 100 is flipped upside and used as a foot bath. It is understood that the above dimensions are provided merely for purposes of illustration rather than limitation.

In at least one example embodiment, the cover 100 may include items to facilitate a pedicure. For example, the cover 100 may be configured with abrasive materials 120, for example, pumice stones that may be attached to an inside surface of the top 118. In the alternative, an inside surface of the top 118 may be lined or coated with an abrasive material.

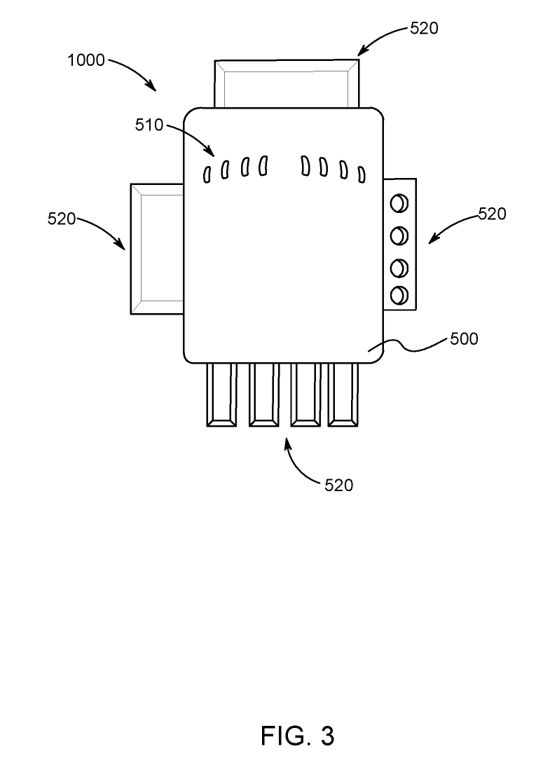

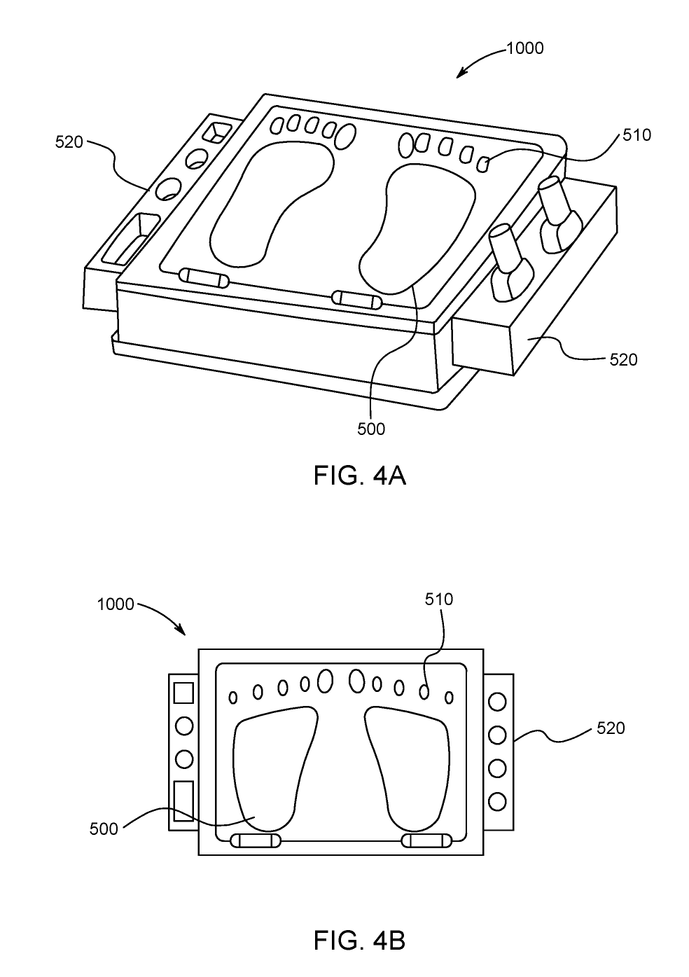

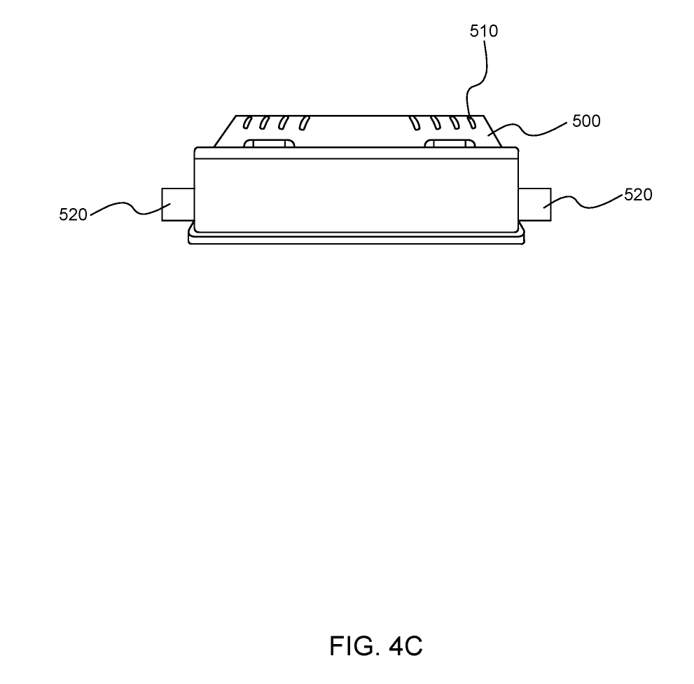

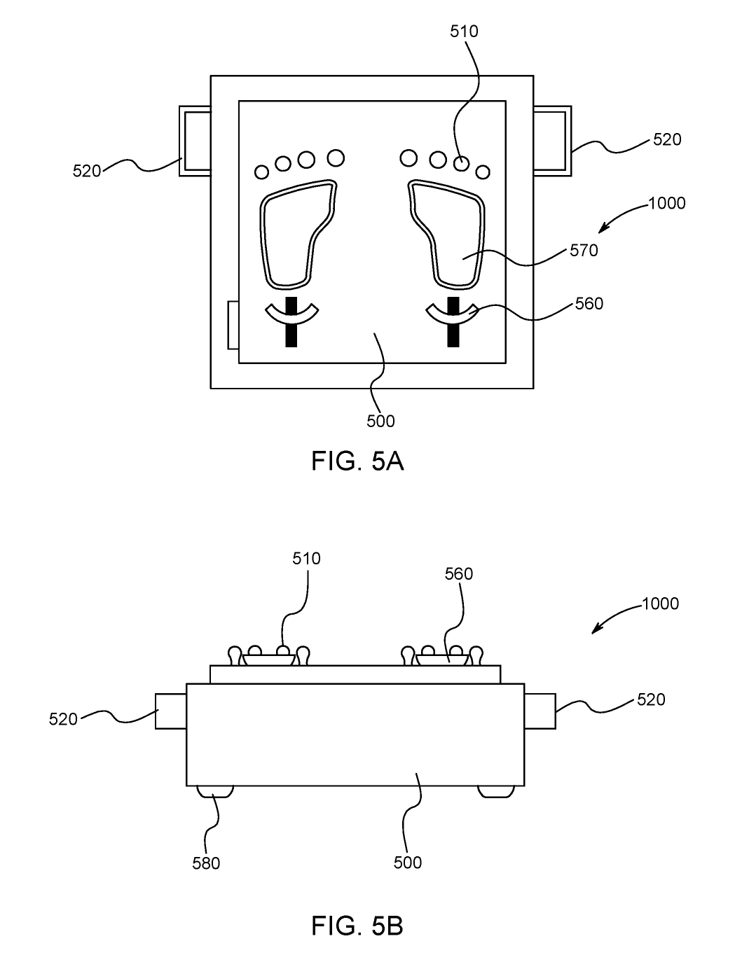

In example embodiments, the pedicure station 500 may be configured to facilitate a pedicure. For example, the pedicure station 500 may be sized so that at least one human foot may rest thereon. For example, the pedicure station 500 may have a length of about fourteen inches, a width of about ten inches, and a depth of about three inches. In one embodiment, the pedicure station 500 includes pop-up toe separators 510 spaced apart and configured to separate human toes as shown for example in FIG. 3. In some embodiments, the pop-up toe separators 510 emerge from the pedicure station 500 via a push button which triggers a release mechanism comprising a spring. In alternative embodiment, the release mechanism comprises a lever. In another embodiment, the toe separators 510 simply protrude from a top surface of the pedicure station 500, as shown for example in FIG. 4B. For example, in this latter embodiment the pedicure station 500 may be made from a plastic material via a molding process and the pedicure station 500 may simply include the toe separators 510 as integral with the rest of the pedicure station 500.

In example embodiments, the pedicure station 500 includes foot pads 570 to provide additional support and comfort during the use of the apparatus and configured to span the entire length, partial length, or at pressure points of a human foot. In certain embodiments, the foot pads 570 are comprised of gel foot pads 570. However, the foot pads 570 may be formed of any suitable size, shape, and design. In a still further embodiment, the pedicure station 500 includes at least one heel rest 560, which may be adjustable to accommodate larger or smaller foot size.

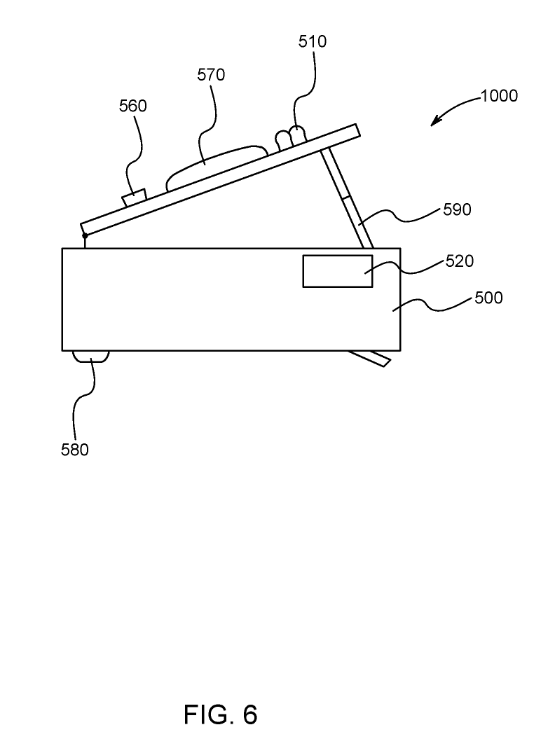

In example embodiments, the pedicure station 500 may also include an adjustable top, as shown in FIG. 6, configured to provide a more comfortable angle for use. In certain embodiments, at least a 25 degree angle is achieved from its closed or non-adjusted position. The top of the pedicure station 500 may be adjusted via any suitable hinge system 590, including a torque hinge, concealed hinge, single knuckle hinge, or any other suitable adjustable hinge. In a further embodiment, additional storage may be accessible when the top of the pedicure station 500 is raised from its closed or non-adjusted position.

In a further embodiment, the pedicure station 500 may also include a plurality of feet 580 which are mounted to the bottom of the pedicure station. These feet 580 may also be adjustable and configured to provide a more comfortable position or to provide additional stability and support for the pedicure station.

In example embodiments, the pedicure station 500 includes storage units that may be open or closed and are contained within the pedicure station 500. For example, as shown in FIGS. 1B and 3 the pedicure station 500 includes at least one storage unit 520, and in a preferred embodiment includes a plurality storage units 520. In this nonlimiting example embodiment, the storage units 520 may be configured to store various items. For example, the first storage unit 520 may resemble a short box with cylindrical openings configured to receive products such as, but not limited to, toe nail polish or toe nail polish remover. A second storage unit 520 may be configured to store additional items such as, but not limited to, brushes and pads. A third storage unit 520 may be configured to store items or receive waste products associated with a pedicure. A fourth storage unit 520 (which may actually be a plurality of storage units) may also be configured to store additional items such as, but not limited to, clippers, scissors, files, knives, polishes, lights, etc. In example embodiments, the storage units 520 may resemble drawers that may be slid in or out of the pedicure station 500.

In example embodiments, the pedicure station 500 may close off an end of the cover 100 and may be connected to the cover 100 in any one of several ways. For example, clips may be used to connect the pedicure station 500 to the cover 100. As another example, edges of the walls 110, 120, 130, and 140 may be fitted with lips which engage lips that may be present on side walls of the pedicure station 500. In this latter embodiment, the pedicure station 500 may simply snap onto the cover 100. In yet another embodiment, the side walls of the pedicure station 500 may be formed with grooves that may accommodate a projection protruding from side walls of the cover 100 to promote a sliding type locking mechanism. In yet another embodiment, a hinge may be present to pivotally connect the cover 100 to the pedicure station 500 and a latch may be present to lock the pedicure station 500 to the cover 100.

Example embodiments of the disclosure have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present disclosure may be practiced otherwise than as specifically described.

What we claim is:

1. A pedicure system comprising:
a pedicure station configured to receive a human foot; and
a plurality of storage units, wherein the storage units are drawers and are contained with the pedicure station.

2. The pedicure system of claim 1, further comprising a cover removably connected to the pedicure system and further configured to receive a human foot and function as a bath.

3. The pedicure system of claim 2, wherein the cover further comprises a non-slip base and a handle.

4. The pedicure of claim 2, wherein the cover further comprises abrasive material affixed to the inside of the cover.

5. The pedicure system of claim 1, wherein the pedicure station further comprises pop-up toe separators.

6. The pedicure system of claim 1, wherein the pedicure station further comprises raised toe separators.

7. The pedicure system of claim 1, wherein the pedicure station further comprises an adjustable footrest.

8. A pedicure system comprising:
a cover, wherein the cover is removably connected to the pedicure system and is further configured to receive a human foot and function as a bath; and
a pedicure station comprising pop-up toe separators.

9. The pedicure system of claim 8, wherein the pedicure station further comprises a plurality of storage units, wherein the storage units are drawers and are contained within the pedicure station.

10. The pedicure system of claim 8, wherein the cover further comprises a non-slip base and a handle.

11. The pedicure of claim 8, wherein the cover further comprises abrasive material affixed to the inside of the cover.

12. The pedicure system of claim 8, wherein the pedicure station further comprises an adjustable footrest.

13. The pedicure system of claim 8, wherein the pedicure station further comprises gel foot pads.

14. The pedicure system of claim 8, wherein the pedicure station further comprises at least one heel rest.

15. A pedicure system comprising:
a cover, wherein the cover is configured to connect to the pedicure system and is further configured to receive a human foot and function as a bath; and
a pedicure station comprising raised toe separators.

16. The pedicure system of claim 15, wherein the pedicure station further comprises a plurality of storage units, wherein the storage units are drawers and are contained within the pedicure station.

17. The pedicure system of claim 15, wherein the cover further comprises a non-slip base and a handle.

18. The pedicure system of claim 15, wherein the cover further comprises abrasive material affixed to the inside of the cover.

19. The pedicure system of claim 15, wherein the pedicure station further comprises an adjustable footrest.

20. The pedicure system of claim 15, wherein the pedicure station further comprises gel foot pads.
